(19) United States
(12) Patent Application Publication
(10) Pub. No.: US 2013/0201164 A1
(43) Pub. Date: Aug. 8, 2013

(54) INFORMATION PROCESSING APPARATUS, INFORMATION PROCESSING UNIT, AND INFORMATION PROCESSING METHOD

(71) Applicants: Shiro Omori, Kanagawa (JP); Masahiro Nakano, Tokyo (JP); Takashi Tsurumoto, Saitama (JP); Tatsushi Banba, Tokyo (JP); Kazumoto Kondo, Kanagawa (JP)

(72) Inventors: Shiro Omori, Kanagawa (JP); Masahiro Nakano, Tokyo (JP); Takashi Tsurumoto, Saitama (JP); Tatsushi Banba, Tokyo (JP); Kazumoto Kondo, Kanagawa (JP)

(73) Assignee: SONY CORPORATION, Tokyo (JP)

(21) Appl. No.: 13/701,345

(22) PCT Filed: Jun. 1, 2011
(86) PCT No.: PCT/JP2011/003082

§ 371 Date: Feb. 15, 2013

(30) Foreign Application Priority Data
Jun. 8, 2010 (JP) 2010-131341

(51) Int. Cl. G09G 5/00

(52) U.S. Cl. CPC G09G 5/003
USPC 345/204

(57) ABSTRACT

An information processing device may include a control unit to control display of an interface on a display of the device based on a use place at which the device is located. The use place may be specified by identification information of an apparatus in which the device is installed.

### TECHNICAL FIELD

The present disclosure relates to an information processing apparatus, an information processing unit, and an information processing method.

### BACKGROUND ART

A portable device such as a portable television, a portable audio device, and a smart phone is generally held by hand, placed on a low board in a living room, or mounted to a wall of a kitchen for use. Further, the portable device is also placed at the side of a bed for use during sleep. As described above, a use place or an installation method of the portable device is various.

The portable devices mostly include a display and a touch panel and thus an operation input can be performed by moving a finger or the like on the touch panel. Further, some of the portable devices include an acceleration sensor or a shock sensor therein and thus an operation input can be performed by giving the device a shock by hitting or shaking. As described above, by making an intuitive operation input possible, operability of the portable device can be improved.

In the case of installing and using the portable device, a cradle stand or the like that supports the portable device (hereinafter, referred to as a “stand”) can be used. The stand can have a charging function for charging the portable device, an external amplifier/speaker function, or the like and provide a function more than a simple stand through interaction with the portable device.

For example, Japanese Patent Application National Publication (Laid-Open) No. 2002-525942 discloses a control system that provides a user control interface according to a position. The control system decides a position at which a user is using a device through a relative position decision device and provides a device interface optimized for a predetermined function to be executed in the environment by the device according to the position.

### CITATION LIST

### Patent Literature

[PTL 1] Japanese Patent Application National Publication (Laid-Open) No. 2002-525942

### SUMMARY OF INVENTION

### Technical Problem

However, when a portable device is connected to a stand and used, effects of installing the portable device in a physically standing manner, feeding power to/charging the portable device, outputting a high quality sound through an external amplifier or speaker, or the like can be obtained, but a further intelligent function is not provided. For example, when a plurality of stands are present, even if installation positions of the stands are different like a kitchen or a bedroom, the obtained effects are the same, and there has been no concept of providing an interface suitable for a use place of the portable device.

Further, the portable device including a display and a touch panel is basically based on the assumption that an operation input is performed by moving a finger on the touch panel regardless of a use place or an installation method of the portable device. In this case, since the operation input is performed by the finger, all objects on a graphical user interface (GUI) that can be operated are displayed with a predetermined size or more. For this reason, there has been a problem in that an object that is desired to be displayed with a small size originally is displayed with a predetermined size or more, and it becomes difficult to display important information that is desired to be displayed with a large size originally.

In addition, when the portable device includes a sensor for detecting a shock on a case, there has been a problem in that a degree of accuracy of detection of the sensor deteriorates according to an installation method of the device. For example, in the case in which the sensor detects when the case of the device is hit, when the device is installed in the stand or the like and used, it is possible to accurately detect when the case is hit. However, when the device is held by hand and used, other shocks may be detected due to influence of other movements. Thus, it is difficult to accurately detect when the case is hit, and a malfunction may be caused.

The present disclosure is made in view of the above-mentioned problems, and aims to provide an information processing apparatus, an information processing unit, and an information processing method which are novel and improved, and which are capable of providing an interface suitable for a use status of a device.

### Solution to Problem

In accordance with one aspect of the embodiments, an information processing device may include a control unit to control display of an interface on a display of the device based on a use place at which the device is located. The use place may be specified by identification information of an apparatus in which the device is installed.

In accordance with another aspect of the embodiments, an apparatus may include an information identification unit that provides identification information to an information processing device when the device is installed in the apparatus. The identification information may specify a use place at which the device is located when the device is installed in the apparatus.

In accordance with another aspect of the embodiments, a method of information processing may include controlling display of an interface on a display of an information processing device based on a use place at which the device is located. The use place may be specified by identification information of an apparatus in which the device is installed.

### Advantageous Effects of Invention

According to the present disclosure, an information processing apparatus, an information processing unit, and an information processing method which are capable of providing an interface suitable for a use status of a device can be provided.

### BRIEF DESCRIPTION OF DRAWINGS

FIG. 1 is an explanation view illustrating an application example an information processing unit according to a first embodiment of the present disclosure.

FIG. 2 is a front view of a portable device according to the same embodiment.

FIG. 3 is a back view of the portable device according to the same embodiment.

FIG. 4 is a front view illustrating a configuration example of a stand according to the same embodiment.

FIG. 5 is a front view illustrating another configuration example of a stand according to the same embodiment.

FIG. 6 is an explanation view illustrating an example of a GUI for a kitchen displayed on a portable device.

FIG. 7 is an explanation view illustrating an example of a GUI for a bedroom displayed on a portable device.

FIG. 8 is a block diagram illustrating a functional configuration of the portable device according to the same embodiment.

FIG. 9 is a flowchart illustrating a GUI decision process performed by a GUI decision processing unit according to the same embodiment.

FIG. 10 is a front view illustrating a configuration example of a stand including an operation section.

FIG. 11 is an explanation view illustrating a display example of an EPG when an operation input is performed by a touch panel.

FIG. 12 is an explanation view illustrating a display example of an EPG when an operation input is performed by an operation section.

FIG. 13 is a block diagram illustrating a configuration example of a hardware configuration of a portable device.

### DESCRIPTION OF EMBODIMENTS

Hereinafter, preferred embodiments of the present disclosure will be described in detail with reference to the appended drawings. Note that, in this specification and the drawings, elements that have substantially the same function and structure are denoted with the same reference signs, and repeated explanation is omitted.

A further description will be made in the following order:

1. First Embodiment (an example of acquiring identification information from a stand to which a portable device is connected)
2. Second Embodiment (an example of a GUI display when a portable device is connected to a stand having an operation section)

### 3. Modified Embodiment

### 4. Hardware Configuration Example

### 1. First Embodiment

### Overview of Information Processing Unit

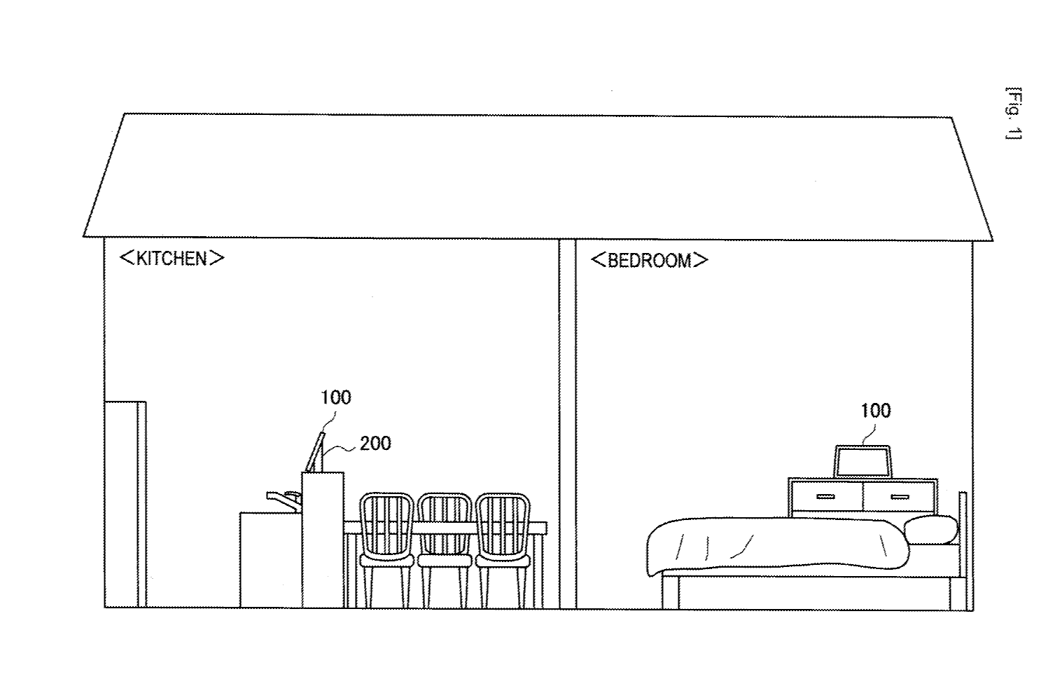

First, an overview of an information processing unit according to a first embodiment of the present disclosure will be described with reference to FIG. 1. FIG. 1 is an explanation view illustrating an application example of an information processing unit according to the present embodiment. The information processing unit according to the present embodiment includes a portable device 100 that provides information and a stand 200 in which the portable device 100 is installed.

The portable device 100 is a multi-function portable device that can provide a user with applications or the like such as a television program, the Internet, an alarm clock function, and a cooking recipe display function. As illustrated in FIG. 1, the portable device 100 can be carried between different rooms like a kitchen and a bedroom and can be used in a place where the user desires to use the portable device 100. The portable device 100 can be held by hand and used, can be used on a table, and can be installed in the stand 200 and used as illustrated in FIG. 1.

In the information processing unit according to the present embodiment, a user interface (UI) of a corresponding device is changed according to a use place of the portable device 100. The portable device 100 can judge the use place of the device, for example, by acquiring corresponding information from the stand 200 having identification information associated with the use place. As a result, according to whether the portable device 100 is used in the kitchen or the bedroom, the interface displayed on the device can be automatically changed, thereby increasing the user's convenience.

A configuration and a function of the information processing unit will be described below in detail.

### Hardware Configuration of Information Processing Unit

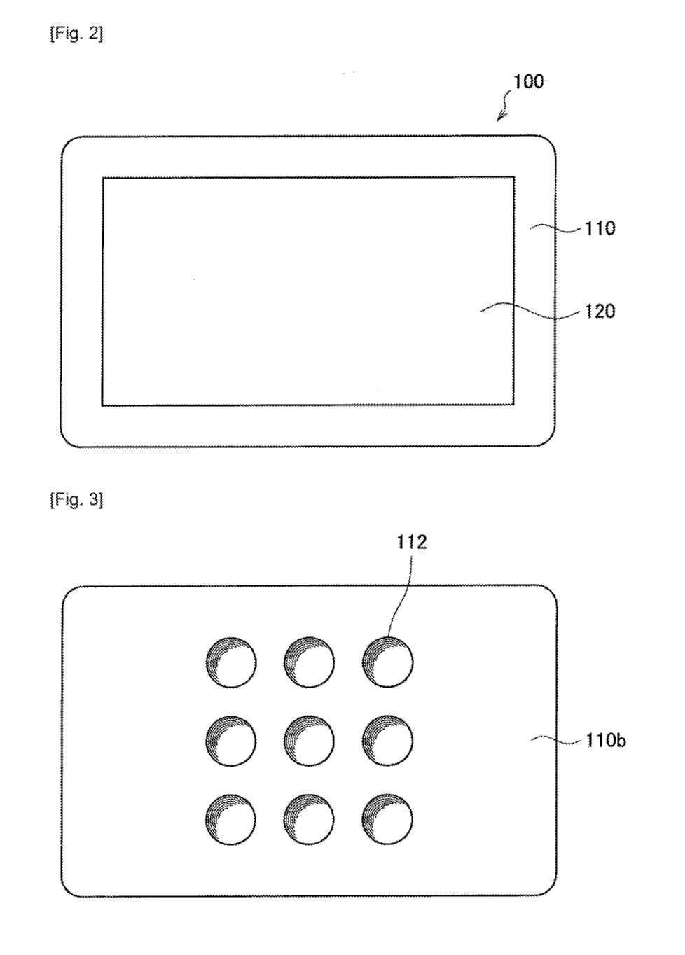

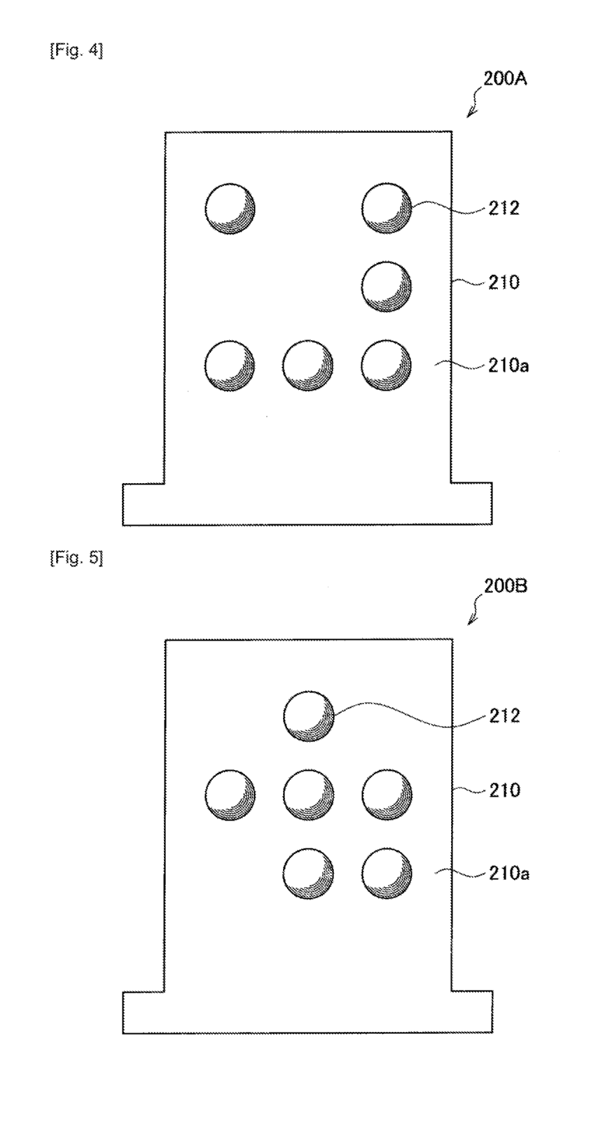

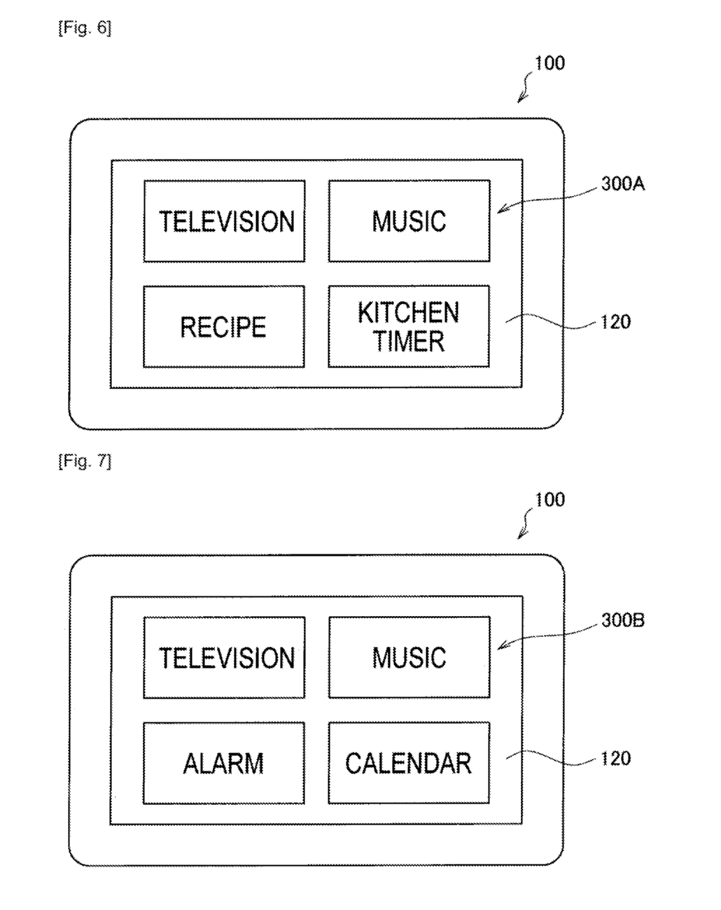

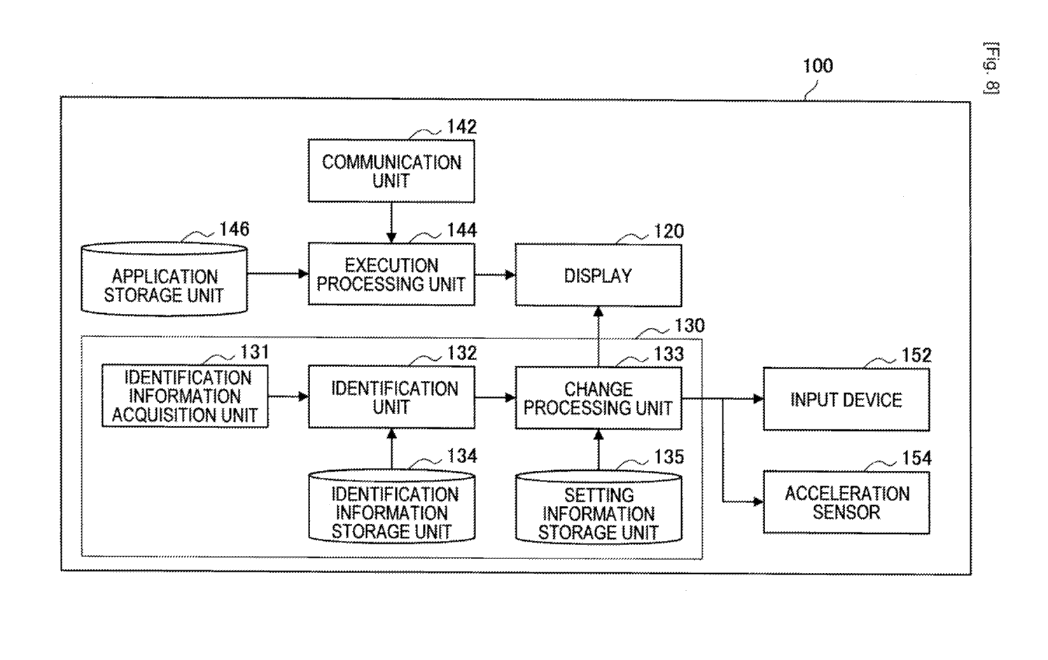

First, a configuration of the information processing unit according to the present embodiment will be described with reference to FIGS. 2 to 7. FIG. 2 is a front view of the portable device 100 according to the present embodiment. FIG. 3 is a back view of the portable device 100 according to the present embodiment. FIG. 4 is a front view illustrating a configuration example of the stand 200 according to the present embodiment. FIG. 5 is a front view illustrating another configuration example of the stand 200 according to the present embodiment. FIG. 6 is an explanation view illustrating an example of a GUI for a kitchen displayed on the portable device 100. FIG. 7 is an explanation view illustrating an example of a GUI for a bedroom displayed on the portable device 100.

### (Portable Device)

The portable device 100 according to the present embodiment is a transportable multi-function portable device as illustrated in FIG. 1. The portable device 100 includes a display 120 that displays information, for example, in a case 110 of a plate form as illustrated in FIG. 2. As the display 120, for example, a liquid crystal display (LCD) or an organic electroluminescence (EL) display can be used. Further, in the portable device 100, a touch sensor (not shown) that detects contact or proximity of an operation body such as a finger is installed to be stacked with the display 120. As the touch sensor, for example, a capacitance type touch sensor that detects a change in capacitance between electrodes that occurs according to the distance between a detection surface and the operation body can be used.

Through the above configuration, the user can perform an operation input with an operational feeling as if he or she directly operates information displayed on the display 120. Here, it is assumed that the side at which the display 120 is installed is a front surface of the device.

A plurality of concave sections 112 are formed on a back surface 100b (a surface opposite to the display 120) of the portable device 100 as illustrated in FIG. 3. For example, in FIG. 3, the concave sections 113 are formed to be arranged in a 3×3 grid form, but the present disclosure is not limited to this example. For example, one or more concave sections can be appropriately installed. However, the number of the concave sections 112 is equal to or more than the number of convex sections of the stand 200. The concave sections 112 are installed to correspond to the convex sections (a reference numeral 212) formed in the stand 200 (200A or 200B) which will be described later. A contact sensor (not shown) is installed in each of the concave sections 112 and detects that the convex portion of the stand 200 is inserted into the concave section 112.

### (Stand)

The portable device 100 according to the present embodiment can be installed in the stand 200 and used. The stand 200 (200A or 200B) includes a support section 210 that supports the portable device 100 as illustrated in FIGS. 4 and 5. On a support surface 210a that faces the back surface 110 of the portable device 100, the convex sections 212 corresponding to the convex section 112 installed in the portable device 100 are formed. The convex sections 212 function as identification information for specifying an installation place of the stand 200, and the stand 200 can be discriminated by an arrangement pattern thereof.

For example, an arrangement pattern of 6 convex sections 212 formed on the stand 200A illustrated in FIG. 4 is different from an arrangement pattern of 6 convex sections 212 formed on the stand 200B illustrated in FIG. 5. As described above, the stands 200 can be discriminated by the arrangement pattern of the convex sections 212. Since each of the stands 200 is previously stored in association with an installation place thereof, the portable device 100 can specify the installation place thereof by discriminating the stand 200. The number of the convex sections 212 that can be formed on the stand 200 may be equal to or less than the number of concave sections 112 formed in the portable device 100. Further, the stand 200 may not include the convex section 212.

### (Display of GUI)

When the portable device 100 is installed in the stand 200, the convex section 212 of the stand 200 is inserted into the concave section 112 formed on the back surface 100b of the portable device 100. At this time, based on the detection result of the contact sensor installed in the convex section 112, the portable device 100 specifies the arrangement pattern of the convex sections 121 of the stand 200 and recognizes the installation place of the stand 200 (that is, the use place of the portable device 100). The portable device 100 displays a menu GUI, in which functions having high use frequency in the specified installation place of the stand 200 are collected, on the display 120.

For example, it is assumed that the stand 200A illustrated in FIG. 4 is previously registered in the portable device 100 as a stand installed in the kitchen, and the stand 200B illustrated in FIG. 5 is previously registered in the portable device 100 as a stand installed in the bedroom. For example, when a connection with the stand 200A is detected, the portable device 100 displays a menu GUI 300A for a kitchen that includes a button “recipe” for starting an application that displays a receipt of a cooking, a button “kitchen timer” for starting a kitchen timer, or the like as illustrated in FIG. 6. Further, for example, when a connection with the stand 200B is detected, the portable device 100 displays a menu GUI 300B for a bedroom that includes a button “alarm” for starting an alarm clock function, a button “calendar” for displaying a calendar, or the like as illustrated in FIG. 7.

As described above, the portable device 100 recognizes the use place by specifying the stand 200 and displays the menu GUI configured to easily start the applications that are frequently used in the use place. As a result, since the content suitable for the place is displayed, the menu can be simplified, and the user's convenience can be improved.

### GUI Display According to Use Place of Portable Device

A functional configuration of the portable device 100 according to the present embodiment and a process of deciding a GUI according to the use place will be described below in further detail.

### (Functional Configuration of Portable Device)

First, a functional configuration of the portable device 100 according to the present embodiment will be described with reference to FIG. 8. FIG. 8 is a block diagram illustrating a functional configuration of the portable device 100 according to the present embodiment.

The portable device 100 according to the present embodiment includes a GUI decision processing unit 130 that recognizes a use place of a corresponding device and provides a GUI suitable for the use place. The GUI decision processing unit 130 includes an identification information acquisition unit 131, an identification unit 132, a change processing unit 133, an identification information storage unit 134, and a setting information storage unit 135 as illustrated in FIG. 8.

The identification information acquisition unit 131 acquires identification information for specifying a position of the portable device 100 and corresponds to the contact sensor installed in each of the concave sections 112 of the back surface 100b of the portable device 100. For example, the identification information acquisition unit 131 acquires the arrangement pattern of the convex portions 212 of the stand 200 in which the portable device 100 is installed as identification information and outputs the identification information to the identification unit 132.

The identification unit 132 recognizes the use place of the portable device 100 based on the identification information acquired by the identification information acquisition unit 131. As will be described later, the identification information is previously stored in the identification information storage unit 134 of the portable device 100 in association with the place. The identification unit 132 matches the identification information acquired from the stand 200 with the identification information stored in the identification information storage unit 134 and recognizes a place associated with the matched identification information as the use place of the portable device 100. The identification unit 132 outputs the place recognized as the use place of the portable device 100 to the change processing unit 133.

The change processing unit 133 decides the GUI to be displayed on the display 120 based on the use place of the portable device 100 recognized by the identification unit 132. The change processing unit 133 acquires GUI setting information corresponding to the use place of the portable device 100 from setting information previously stored in the setting information storage unit 135 which will be described later and displays the GUI setting information on the display 120.

The identification information storage unit 134 is a storage unit in which the identification information acquired by the identification information acquisition unit 131 is stored in association with the place. For example, the arrangement patterns of the convex sections 212 of the stands 200A and 200B illustrated in FIGS. 4 and 5 are used as the identification information. At this time, storage is performed in the identification information storage unit 134, for example, such that the arrangement pattern 212 of the convex sections 212 of the stand 200A is stored for a kitchen, and the arrangement pattern of the convex sections 212 of the stand 200B is stored for a bedroom. Through the identification unit 132 specifying the place associated with the identification information acquired by the identification information acquisition unit 131 with reference to the identification information storage unit 134, the portable device 100 can recognize the use place of the portable device 100.

The setting information storage unit 135 stores setting information in association with the use place of the portable device 100 and the menu GUI that is displayed in the corresponding use place. For example, on the use place “kitchen,” the setting information is set to display an application (television) for displaying a television program, an application (music) for reproducing music, an application (recipe) for displaying a recipe of a cooking, and an application (kitchen timer) of a kitchen timer on the menu GUI. Alternatively, on the use place “bedroom,” the setting information is set to display an application (television) for displaying a television program, an application (music) for reproducing music, an application (alarm) of an alarm clock function, and an application (calendar) for displaying a calendar.

The setting information may be previously set in the portable device 100 or may be set by the user. The portable device 100 displays the menu GUI suitable for the use place of the device on the display 120 with reference to the setting information storage unit 135 through the change processing unit 133.

The portable device 100 further includes a communication unit 142, an execution processing unit 144, and an application storage unit 146 as functions for providing applications. If the user selects an application to execute from the menu GUI displayed on the display 120 through the GUI decision processing unit 130, the execution processing unit 144 starts an execution process of the selected application. The execution processing unit 144 acquires the application to execute through the communication unit 142 or the application storage unit 146 and executes the application. If the application is executed, for example, the television program is displayed on the display 120, or music is output from a speaker (not shown).

The portable device 100 according to the present embodiment further includes an input device 152 such as a touch panel and is configured to be capable of inputting operation information. Further, the portable device 100 includes an acceleration sensor 154 installed therein, and thus the user can perform an operation input of, for example, hitting the case 110 to give a shock.

### (GUI Decision Process)

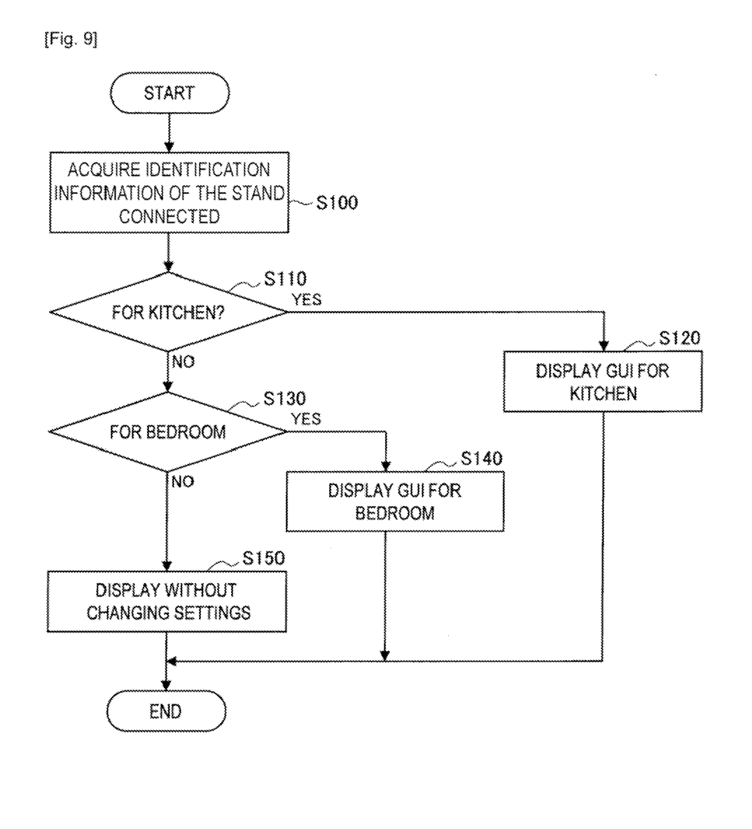

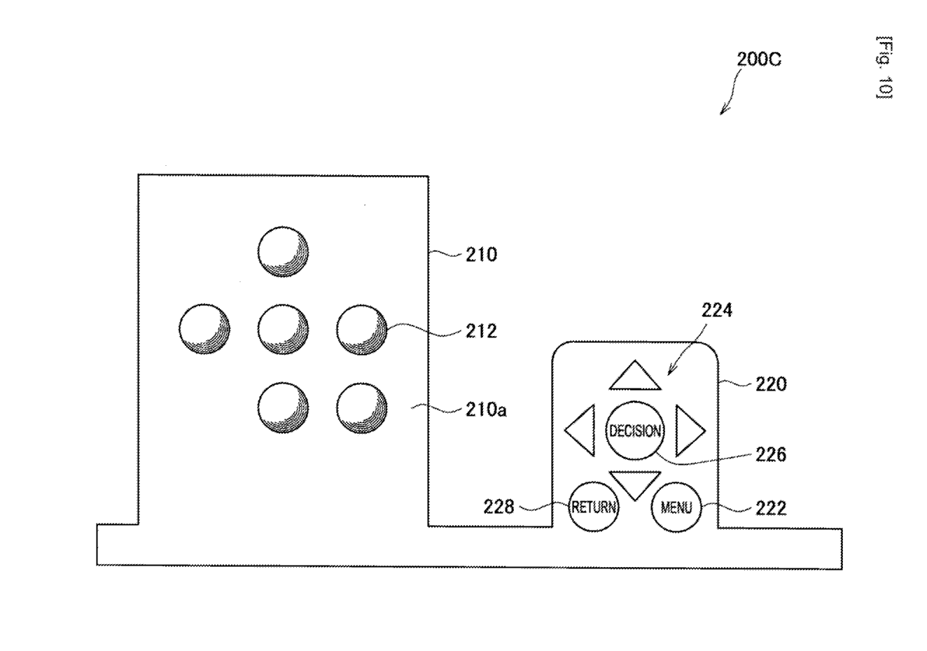

The portable device 100 can display the menu GUI corresponding to the use place of the device through the GUI decision processing unit 130. This process is illustrated in FIG. 9. A process of specifying the use place of the portable device 100 by identifying the stand 200 and deciding the menu GUI to be displayed on the display 120, which is illustrated in FIGS. 1 to 7, will be described below. It is assumed that the portable device 100 stores information in which the stand 200A and the stand 200B are associated with the installation places thereof in the identification information stage unit 134 as the identification information.

When the portable device 100 is installed in the stand 200, the identification information acquisition unit 131 of the portable device 100 acquires the identification information of the stand 200 (S 100). The identification information acquisition unit 131 detects the convex section 212 of the stand 200 inserted into the concave section 112 of the back surface 100b of the portable device 100 and recognizes the arrangement pattern of the convex section 212 formed in the stand 200. The identification information acquisition unit 131 outputs the recognized arrangement pattern of the convex section 212 to the identification unit 132.

Next, the identification unit 132 performs a matching process with the identification information stored in the identification information storage unit 134 based on the arrangement pattern of the convex section 212 and specifies the stand 200 in which the portable device 100 is installed. First, it is confirmed whether or not the arrangement pattern of the convex section 212 is the arrangement pattern of the stand 200A installed in the kitchen (S 110). When the identification information matched with the arrangement pattern acquired by the identification information acquisition unit 131 is present, the identification unit 132 judges that the portable device 100 has been installed in the stand 200A installed in the kitchen and instructs the change processing unit 133 to display the GUI for the kitchen. The change processing unit 133 that has received the instruction acquires the GUI setting information for the kitchen from the setting information storage unit 135 and displays the menu GUI for the kitchen on the display 120 (S120).

Meanwhile, when the identification information matched with the arrangement pattern acquired by the identification information acquisition unit 131 is not present, the identification unit 132 then confirms whether or not the arrangement pattern of the convex section 212 is the arrangement pattern of the stand 200B installed in the bedroom (S 130). When the identification information matched with the arrangement pattern acquired by the identification information acquisition unit 131 is present, the identification unit 132 judges that the portable device 100 has been installed in the stand 200B installed in the bedroom and instructs the change processing unit 133 to display the GUI for the bedroom. The change processing unit 133 that has received the instruction acquires the GUI setting information for the bedroom from the setting information storage unit 135 and displays the menu GUI for the bedroom on the display 120 (S140).

The present embodiment has been described in connection with the case in which the portable device 100 is installed in the two kinds of stands 200, but the portable device 100 can be installed in more kinds of stands 200. In this case, the identification unit 132 preferably performs the matching process between the identification information of the stands 200 and the arrangement pattern acquired by the identification information acquisition unit 131 in the same manner as described above.

When it is judged based on the matching process on the identification information that the identification information matched with the acquired arrangement pattern of the convex section 212 is not present, the identification unit 132 instructs the change processing unit 133 to display the menu GUI set as initial setting on the display 120. The change processing unit 133 that has received the instruction acquires the initial setting of the menu GUI from the setting information storage unit 135 and displays the initial setting of the menu GUI on the display 120 (S150).

The menu GUI display decision process performed by the portable device 100 according to the present embodiment has been described above. As described above, the portable device 100 specifies the place where it is being used by detecting and recognizing the stand 200 in which the device is installed. By displaying the menu GUI corresponding to the use place of the device on the display 120, applications used with high frequency in the place can be easily executed, and thus the user's convenience can be improved.

### 2. Second Embodiment

Next, an information processing unit according to a second embodiment of the present disclosure will be described with reference to FIGS. 10 to 12. The information processing unit according to the present embodiment includes a portable device 100 and a stand 200 that supports the portable device 100 similarly to the first embodiment. A hardware configuration and a functional configuration are basically similar to those in the first embodiment, but the stand 200 (200C) according to the present embodiment is different from that of the first embodiment in that an operation section 220 for operating the portable device 100 is installed in addition to a support section 210 that supports the portable device 100. A process in the portable device 100 when the portable device 100 is installed in the stand 200C will be described below. The functional configuration of the portable device 100 according to the present embodiment is the same as the configuration illustrated in FIG. 8, and thus a description thereof will be omitted.

### Change of Display Method and Operation Method of GUI According to Connection Target

The stand 200C according to the present embodiment includes the support section 210 for supporting the portable device 100 and the operation section 220 for operating the portable device 100 as illustrated in FIG. 10. On a support surface 210a of the support section 210, similarly to the stands 200A and 200B of the first embodiment illustrated in FIGS. 4 and 5, convex sections 212 are installed with different patterns for each of the stands. The portable device 100 can specify the stand 200 in which the portable device 100 is installed by recognizing the arrangement pattern of the convex sections 212.

Further, the operation section 220 for operating the portable device 100 installed in the stand 200C is installed in the stand 200C. On the operation section 220, a menu button 222 for displaying the menu GUI on the display 120 of the portable device 100, a cursor key 224 for allowing the user to select an application to execute from the menu, or the like are installed as illustrated in FIG. 10. Further, a decision button 226 for deciding the selected content and a return button 228 for returning the display content of the display 120 to a previous screen are also installed on the operation section 220.

The operation section 220 can be enabled when the portable device 100 is installed in the stand 200C. The stand 200C can detect the installation of the portable device 100, for example, by providing an infrared ray sensor, a button, or the like in the support surface 210a of the support section 210. Further, the stand 200C can detect the installation of the portable device 100 by establishing a communication connection with the portable device 100 in a wired or wireless manner.

Since the operation section 220 is installed in the stand 200C, an operation to input information to the portable device 100 may be performed by several methods. Thus, in the portable device 100 according to the present embodiment, the form of an operation input is switched according to the use status of the portable device 100 and a GUI easily operated by the user is provided.

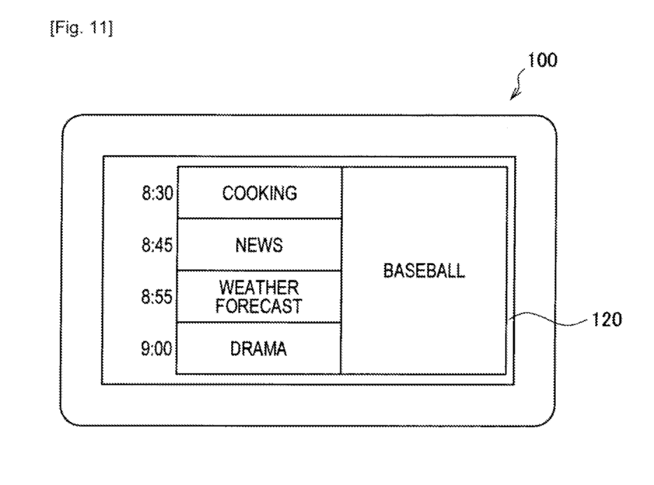

For example, let us consider a case in which the user displays an electronic program guide (EPG) on the display 120 of the portable device 100 and confirms a television program to be broadcasted. When an input operation is performed through a touch panel of the portable device 100, in order to easily operate each television program of the EPG by the finger, as illustrated in FIG. 11, a program column is displayed with a predetermined size or more regardless of the length of a program time. In the example illustrated in FIG. 11, the program column is taken on a large scale in a vertical direction, and short time programs having a short program time, for example, television programs of 15 minutes or less, have the same height in length of the program column in the vertical direction.

If the EPG is displayed as described above, the input operation is easily performed through the touch panel, but it is difficult to intuitively recognize the length of the program time of each television program. Further, since the program column has a predetermined size or more on the short time program, the program column on the television program having a long program time decreases regardless of the length of the program time since the display area of the display 120 is restricted. For this reason, the detailed content of a program that could be displayed when the program column of the television program having the long program time is large may not be displayed.

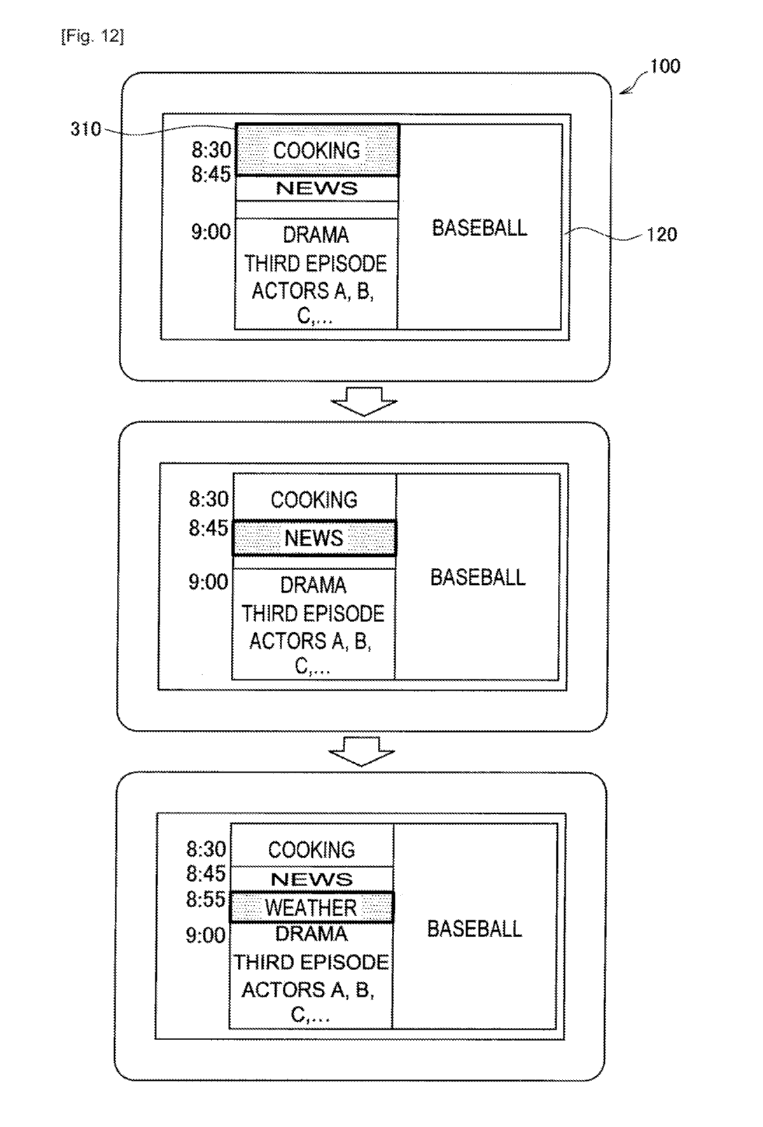

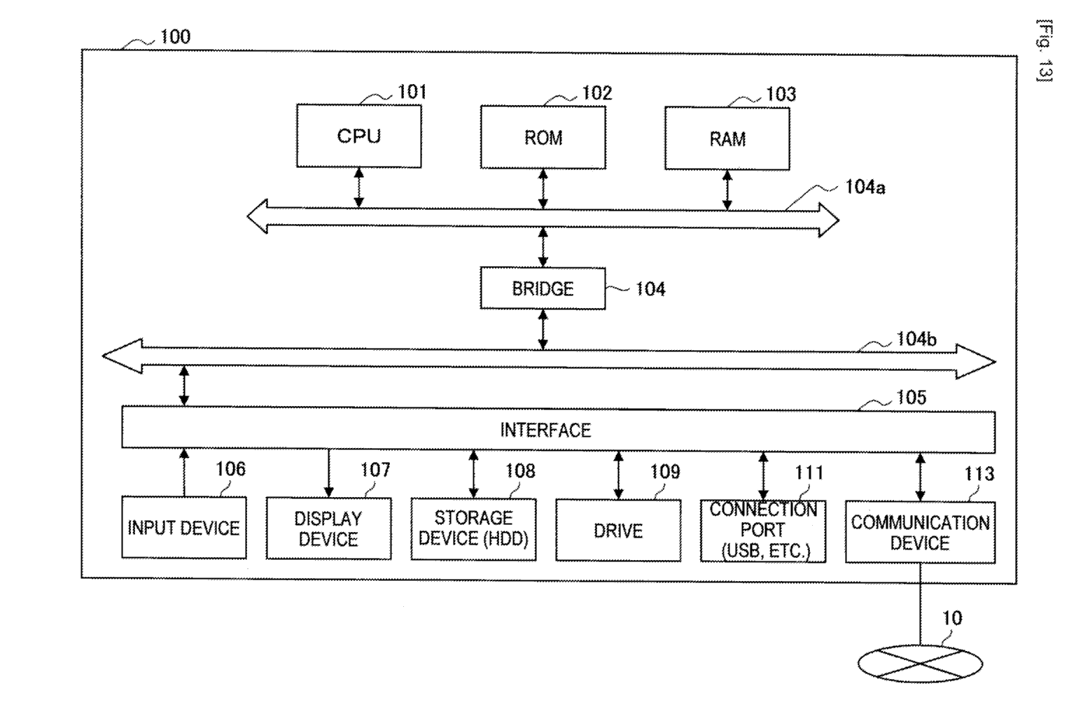

However, the portable device 100 can be operated by the operation section 220 of the stand 200C. Thus, even if the program column of a predetermined size or more is not secured like a case of using the touch panel, the operation input can be easily performed. Let us assume that when the size of the program column of the EPG is set according to the length of the program time, for example, as illustrated in FIG. 12, a program to be broadcast between news or a drama is a short time program, and it is in a state in which information on the program is not displayed. In this case, even when the size of the program column decreases and becomes difficult to operate by the finger, since the user can move a cursor 310 using the cursor key 224 of the operation section 220 of the stand 200C, the input operation can be performed without any program.

Further, as illustrated in FIG. 12, for the program column focused by the cursor 310, the program column temporarily becomes broad and has sufficient size to display at least a program name. Thus, information on a program that is not normally displayed can be displayed. Further, the size of the program column is decided according to the program time. Thus, the user can intuitively easily recognize the program time, and the television program having the long program time can be displayed so that even the detailed content thereof can be recognized at a glance.

As described above, according to the use status of the portable device 100, i.e., whether the portable device 100 is held by hand and used or installed in the stand 200 and used, not only the content of the GUI but also the display method or the operation method can be changed.

### Change of GUI According to Installation Position of Portable Device

In the present embodiment, a method of selecting an object of the GUI has been changed by an input device for operating the portable device 100, but for example, the GUI to provide may be changed according to the installation position of the portable device 100. For example, let us assume that there are a prop stand for propping up the portable device 100 against the user's hand and a wall stand installed on a wall. Generally, when the portable device 100 is installed in the wall stand, the portable device 100 is installed at a position further away from the user compared to when installed in the prop stand. Thus, using a remote controller is more convenient than the touch panel of the portable device 100 as an input device for operating the portable device 100 installed in the wall stand.

To allow the user to view the display 120 of the portable device 120 from a distance, the GUI is changed by the change processing unit 133 so that each object that constitutes the GUI can be displayed on a large scale or the GUI can be displayed to be easily viewed with clear contrast. Such GUI setting can be previously set in the setting information storage unit 135.

### 3. Modified Embodiment

The present disclosure is not limited to the configuration of the information processing unit described in connection with the above described embodiments, and a configuration thereof or a provision method of the GUI can be appropriately changed.

### Detection Method of Identification Information

In order to recognize the use place of the portable device 100, in the present embodiment, the process of acquiring the identification information of the stand 200 in which the portable device 100 is installed and recognizing the installation place of the corresponding stand 200 has been performed. In this case, the portable device 100 has specified its own use place by mechanically recognizing a physical pattern of a plurality of concaves or convexes by using the arrangement pattern of the convex sections 212 formed in the support surface 210a of the stand 200 as the identification information, but the present disclosure is not limited to the above examples. For example, a radio integrated circuit (IC) tag may be embedded in each stand 200, and a reader may be installed in the portable device 100. In this case, the stand 200 can be identified by reading the radio IC tag of the stand 200 in which the corresponding device is installed through the reader of the portable device 100.

Further, when the portable device 100 can perform WiFi radio communication, a place where the portable device 100 is being used can be estimated based on a positional relationship with a WiFi access point. As a result, for example, the portable device 100 can recognize whether it is being used in the kitchen or the bedroom and provide the GUI corresponding to the use place. The position of the portable device 100 may be acquired using a global positioning system (GPS) or the like. The use place may be judged based on GPS information to provide the GUI suitable for the use place.

Further, in the second embodiment, when the GUI display is changed by a change of an input device, the GUI display may be changed according to whether or not the portable device 100 has recognized a device class of a human interface device (HID). If an input device such as a mouse or a keyboard is connected with the portable device 100, the portable device 100 may acquire the device class of the connected input device and display the GUI suitable for the use place in a form that is easy to input through the input device. As a result, the user's convenience can be improved, and the operability can increase.

Further, the GUI may be changed according to the use place of the portable device 100, but the display content of the display 120 may be changed according to the installation method of the device. For example, a sensor that can detect an installation angle of the device may be installed in the portable device 100, and the content of the GUI to provide may be changed according to whether the rectangular display 120 is installed vertically long or horizontally long. Specifically, when the display 120 is installed vertically long in the stand 200 installed in the kitchen, the portable device 100 automatically starts an application of a recipe of a cooking. However, when the display 120 is installed horizontally long, the portable device 100 automatically starts an application that provides a television program.

Further, in the portable device 100, the GUI displayed on the display 120 may be changed according to an inclination of the display surface of the display 120 on the installation surface of the stand 200. As described above, an application that is desired to be used can directly be started according to the use method as well as the use place of the portable device 100, and thus the convenience can increase.

### Display Content of GUI Corresponding to Use Place of Portable Device

In the above-described embodiments, the portable device 100 performs the process of acquiring the identification information of the stand 200 in which the portable device 100 is installed in order to specify the use place of the device and displaying the GUI suitable for the specified use place of the device based on the identification information. At this time, as an example of the GUI to display, a simple menu GUI on which the buttons for starting the applications are installed has been described, but the present disclosure is not limited to the above example.

For example, it is considered that a recipe of a cooking can be read at any place, but it is considered that the user will mostly operate the kitchen timer while reading the recipe in the kitchen. Thus, when the kitchen is recognized by the identification information acquired from the stand 200 or when the user is reading the recipe (the recipe application is starting), the portable device 100 may display an object for starting the application of the kitchen timer on the display 120. As described above, the content of the started application can be flexibly changed according to the use place of the portable device 100.

Further, a kind of the menu GUI described in the above embodiments or a kind of the application displayed on the menu GUI are previously set, but the present disclosure is not limited to the above example, and the user can change the menu GUI and the application according to his/her preference. Alternatively, an application provided by an on-line update through the communication unit 142 can be displayed on the menu GUI, and the configuration of the menu GUI itself can be changed. Even when the number of stands 200 for setting the portable device 100 increases, the present disclosure can be applied such that the menu GUI suitable for the installation place of the added stand 200 is downloaded through a network and stored in the setting information storage unit 135.

Further, the change processing unit 133 of the portable device 100 may change the display content of the GUI, or may automatically change brightness of the display 120, and the like according to the use place of the portable device 100. For example, generally, the kitchen is bright, and the bedroom is dark. Thus, when it is recognized that the portable device 100 is being used in the kitchen, the display 120 becomes bright, whereas when it is recognized that the portable device 100 is being used in the bedroom, the display 120 becomes dark. As described above, by displaying the GUI with the appropriate brightness of the screen according to the use place, the display that is comfortable for the user to see can be provided.

Further, the application to be automatically executed may be set according to the use place of the portable device. For example, when the portable device 100 is used in the kitchen, the recipe application may automatically start, and when used in the bedroom, the alarm clock application may automatically start. The application to automatically start may be set by the user, and the application having high use frequency may be set by a judgment of the device. Setting of the application to automatically start may be stored in the setting information storage unit 135. As described above, by automatically starting the application according to the use place through the change processing unit 133, the user's effort can be saved, and the convenience can increase.

### Change of GUI Display According to User

The user who uses the portable device 100 is not limited to one person. At this time, the user considered to use the corresponding device may be changed according to the use place of the portable device 100. For example, it may be considered that only a wife uses the portable device 100 in the kitchen, and both a husband and the wife use the portable device 100 in the bedroom. For example, when starting an application that sets up an account of each user or the like such as an electronic mail, the change processing unit 133 displays an account of the wife in the kitchen as the default. Further, in the bedroom, the change processing unit 133 displays the UI for selecting the accounts of both the husband and the wife on the display 120. As described above, the user who is using the corresponding device may be estimated according to the use place of the portable device 100, and the GUI corresponding to the user can automatically be provided.

### Validation/Invalidation of Input Device

In the portable device 100, the acceleration sensor 154 that can detect a shock on the case 110 may be installed as illustrated in FIG. 8. For example, a predetermined application may be executed by hitting the portable device 100. When the user holds and uses the portable device 100, the case 110 being hit may not accurately be detected due to influence of other movements of the user. Further, when the input operation is performed by hitting the case 110, the portable device 100 is usually installed on a table or the like.

When it is detected that the portable device 100 is installed in the stand 200, the acceleration sensor 154 of the portable device 100 is validated, and thus the input operation of hitting the case 110 can be performed. However, when the portable device 100 is not installed in the stand 200, the acceleration sensor 154 is invalidated, so that the input operation of hitting the case 110 is not received. By validating or invalidating the acceleration sensor 154 according to the use status of the portable device 100 as described above, it is possible to prevent a situation in which a detection result of the acceleration sensor 154 is erroneously judged and thus an unintended device operation is performed.

### 4. Hardware Configuration Example

The process performed by the portable device 100 according to the present embodiment may be implemented by hardware or software. In this case, the portable device 100 may be constructed as a computer illustrated in FIG. 13. A hardware configuration example of the portable device 100 according to the present embodiment will be described below with reference to FIG. 13.

The portable device 100 according to the present embodiment may be implemented by a processing apparatus such as a computer as described above. The portable device 100 includes a central processing unit (CPU) 101, a read only memory (ROM) 102, a random access memory (RAM) 103, and a host bus 104a as illustrated in FIG. 13. The portable device 100 further includes a bridge 104, an external bus 104b, an interface 105, an input device 106, an output device 107, a storage device (HDD) 108, a drive 109, a connection port 111, and a communication device 113.

The CPU 101 functions as a calculation processing device and a control device and controls the entire operation of the portable device 100 according to various programs. Further, the CPU 101 may be a microprocessor. The ROM 102 stores a program and a calculation parameter used by the CPU 101. The RAM 103 temporarily stores a program used in execution of the CPU 101 and a parameter that appropriately varies in the execution. The components are connected with each other by the host bus 104a that includes, for example, a CPU bus.

The host bus 104a is connected with the external bus 104b such as a peripheral component interconnect/interface (PCI) bus via the bridge 104. The host bus 104a, the bridge 104, and the external bus 104b are not necessarily separately constructed, and their functions may be implemented by a single bus.

The input device 106 includes an input unit through which the user inputs information such as a mouse, a keyboard, a touch panel, a button, a microphone, a switch, and a lever and an input control circuit that generates an input signal based on the input from the user and outputs the input signal to the CPU 101. The output device 107 includes, for example, a display device such as an LCD device, an organic light emitting diode (OLED) device, and a lamp or a voice output device such as a speaker.

The storage device 108 is an example of a storage unit of the portable device 100 and is an apparatus for data storage. The storage device 108 may include a storage medium, a recording apparatus that records data in the storage medium, a reading apparatus that reads data from the storage medium, and an erasing apparatus that erases data recorded in the storage medium. The storage device 108 includes, for example, a hard disk drive (HDD). The storage device 108 drives a hard disk to store a program executed by the CPU 101 or a variety of data.

The drive 109 is a reader/writer for a storage medium and is installed inside the portable device 100 or attached to outside of the portable device 100. The drive 109 reads information recorded on a removable storage medium such as a magnetic disk, an optical disc, a magnetic optical disc, or a semiconductor memory mounted therein and outputs the information to the RAM 103.

The connection port 111 is an interface connected with an external apparatus and is a port for connection with an external apparatus that can transmit data through, for example, a universal serial bus (USB). The communication device 113 is a communication interface that includes a communication device for connecting with a communication network 10. Further, the communication device 113 may include a communication device that supports a wireless local area network (LAN), a communication device that supports a wireless USB, or a wire communication device that performs wired communication.

The exemplary embodiments of the present disclosure have been described hereinbefore with reference to the appended drawings, but the present disclosure is not limited to the above examples. A person having ordinary skill in the art would understand that various modifications or variations can be made within the scope of the technical spirit defined in the claims and included within the technical scope of the disclosure.

For example, in the above-described embodiments, the operation section 220 illustrated in FIG. 10 is formed to be integrated with the support section 210 of the stand 200C, but the present disclosure is not limited thereto. For example, the operation section 220 may be configured to be used separately from the stand 200C. In this case, the operation section 220 functions as a remote controller that operates the portable device 100.

Further, in the above described embodiments, the convex section 212 of the stand 200 is fixed to the support surface 210a, but the present disclosure is not limited thereto. For example, the convex section 212 is detachable, and the user can change the arrangement of the convex section 212. Further, a switch or the like that switches the identification information for specifying the installation place may be installed in the stand 200. As described above, by switching the identification information of the arrangement pattern or the like of the convex section 212, when the installation place of the stand 200 is moved, the menu GUI or the like suitable for the moved place can be displayed.

Further, the above described embodiments have been described in connection with the information processing unit that includes the portable device 100 that can be portable and the stand 200 that supports the portable device 100, but the present disclosure is not limited thereto. For example, the device that provides the GUI is not necessarily be portable and may be, for example, a large-scale television. In this case, for example, when a keyboard is connected with the television, the UI or the like displayed on the display of the television may be changed.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

100 Portable device
110 Case
112 Concave section
120 Display
120 GUI decision processing unit
131 Identification information acquisition unit
132 Identification unit
133 Change processing unit
134 Identification information storage unit
135 Setting information storage unit
142 Communication unit
144 Execution processing unit
146 Application storage unit
152 Input device
154 Acceleration unit
200, 200A, 200B, 200C Stand
210 Support section
212 Convex section
220 Operation section

1. An information processing device, comprising:
a control unit to control display of an interface on a display of the device based on a use place at which the device is located, wherein the use place is specified by identification information of an apparatus in which the device is installed.

2. The information processing device of claim 1, wherein the identification information is acquired from the apparatus by a communication.

3. The information processing device of claim 1 further comprising:
an identification information acquiring unit for acquiring the identification information from the apparatus.

4. The information processing device of claim 3, wherein the identification information acquiring unit is a contact sensor.

5. The information processing device of claim 3, wherein the identification information acquiring unit is a reader operable to read a radio integrated circuit tag.

6. The information processing device of claim 1 further comprising:
at least one identification information acquiring unit arranged to oppose, and to acquire the identification information from, at least one corresponding identification information unit of the apparatus when the device is installed in the apparatus.

7. The information processing device of claim 1, wherein the control unit controls display of the interface on the display of the device according to an orientation of the device when the device is installed in the apparatus.

8. The information processing device of claim 7, wherein the orientation is an installation angle of the device when the device is installed in the apparatus.

9. The information processing device of claim 7, wherein the orientation is an inclination of the display of the device when the device is installed in the apparatus.

10. The information processing device of claim 1, wherein the control unit controls display of the interface on the display of the device according to an inclination of the display of the device and the identification information of the apparatus when the device is installed in the apparatus.

11. The information processing device of claim 1, wherein the control unit controls start of an application at the device according to the identification information of the apparatus when the device is installed in the apparatus.

12. The information processing device of claim 1, wherein the control unit validates an input operation detected at the device according to an installation status of the device.

13. The information processing device of claim 12, wherein, when the input operation is detected and the installation status is the device is installed in the apparatus, the control unit validates the input operation, and when the input operation is detected and the installation status is the device is not installed in the apparatus, the control unit invalidates the input operation.

14. The information processing device of claim 12, wherein the input operation is detected at an acceleration sensor of the device.

15. An apparatus comprising:
an information identification unit that provides identification information to an information processing device when the device is installed in the apparatus, wherein the identification information specifies a use place at which the device is located when the device is installed in the apparatus.

16. The apparatus of claim 15, wherein the information identification unit is arranged to oppose a corresponding information identification acquiring unit of the information processing device when the device is installed in the apparatus, wherein the information identification acquiring unit is for acquiring the identification information from the apparatus.

17. The apparatus of claim 15, wherein the information identification unit is arranged to oppose a corresponding information identification acquiring unit of the information processing device when the device is installed in the apparatus, wherein an arrangement of the information identification unit functions as the identification information that specifies the use place.

18. The apparatus of claim 15 further comprising:
an operation section for operating the device when the device is installed in the operation section.

19. The apparatus of claim 15 further comprising:
a detection unit to detect installation of the device in the apparatus.

20. The apparatus of claim 19, wherein the detection unit detects installation of the device by communication with the device.

21. The apparatus of claim 21, wherein the communication is wired or wireless.

22. The apparatus of claim 15, wherein the information identification unit is a radio integrated circuit tag.

23. An information processing system comprising:
an information processing device including a control unit to control display on a display of the device; and
an apparatus including an information identification unit that provides identification information when the device is installed in the apparatus,
wherein the control unit of the device controls display of an interface on the display of the device based on a use place at which the device is located, wherein the use place is specified by the identification information of the apparatus in which the device is installed.

24. The system of claim 23, wherein the device includes an information identification acquiring unit to acquire the identification information from an information identification unit of the apparatus when the device is installed in the apparatus.

25. The system of claim 24, wherein the identification information acquiring unit is a contact sensor.

26. The system of claim 24, wherein the information identification unit of the apparatus is arranged to oppose a corresponding information identification acquiring unit of the device when the device is installed in the apparatus, wherein an arrangement of the information identification unit functions as the identification information that specifies the use place.

27. The system of claim 23, wherein the control unit validates an input operation detected at the device according to an installation status of the device.

28. The system of claim 27, wherein, when the input operation is detected and the installation status is the device is installed in the apparatus, the control unit validates the input operation, and when the input operation is detected and the installation status is the device is not installed in the apparatus, the control unit invalidates the input operation.

29. The system of claim 28, wherein the input operation is detected at an acceleration sensor of the device.

30. A method of information processing comprising:
controlling display of an interface on a display of an information processing device based on a use place at which the device is located, wherein the use place is specified by identification information of an apparatus in which the device is installed.
